(19) United States
(12) Patent Application Publication
(10) Pub. No.: US 2021/0258165 A1
(43) Pub. Date: Aug. 19, 2021

(54) ACCESS CONTROL SYSTEM WITH ONE-TIME PASSWORD USING ENCRYPTED QUICK RESPONSE CODE

(71) Applicant: Sang Hoon Woo, Seongnam-si (KR)

(72) Inventor: Sang Hoon Woo, Seongnam-si (KR)

(21) Appl. No.: 16/792,879

(22) Filed: Feb. 17, 2020

(51) Int. Cl. H04L 9/32; G06F 21/45; H04L 9/08; G06K 19/06; G06K 7/14

(52) U.S. Cl. CPC H04L 9/3228; G06F 21/45; H04M 1/725; G06K 19/06037; G06K 7/1417; H04L 9/0819

(57) ABSTRACT

Systems and methods for controlling access to a lock with one-time password using an encrypted quick response (QR) code. A method for retrieving a password embedded in a QR code by use of a mobile device includes: capturing and scanning an image of a QR code that is displayed on a lock and includes information of an identification (ID) of the lock and a password encrypted with an encryption key; extracting the ID of the lock and the encrypted password from the scanned image; sending a request for access of the lock, the request including the ID of the lock and an ID of the user of the mobile device; receiving an access notification that includes a decryption key; decrypting the encrypted password using the decryption key; and displaying the decrypted password on a display of the mobile device. The decrypted password is used to unlock the lock.

### A. TECHNICAL FIELD

The present invention relates to an access control system, more particularly, to a system for controlling access to a lock with one-time password using an encrypted quick response (QR) code.

### B. DESCRIPTION OF THE RELATED ART

The two most widely used forms of a digital lock are the passcode based system and the key card based system. The passcode based system compares the input code to a preset passcode and grants access if the two match and denies access otherwise. Typically, the majority of the users keep a short passcode and do not update the passcode regularly, for the sake of convenience. This may introduce a significant security flaw, where it is easy for anyone to pick up the passcode and once the passcode is leaked, the lock is completely compromised.

The key card based system, on the other hand, utilizes a physical item, such as a card or a near-field communication (NFC) tag, to be read by the lock system. If the key, which is embedded in the card or tag, is authorized to open the lock, the lock system will grant access. The key card based system may include an inconvenience for the users of having to carry an additional item specifically for the lock system. Also, if the lock system has no connection to a central system, the access control process becomes more difficult; in the case of a lost card, it is hard to remove access authority from the lost card, resulting in replacement of the lock itself.

As such, there is a need for lock systems that prevent the issue of leaked passcode in the conventional systems to thereby have improved security aspects.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 (“FIG.”) shows a schematic diagram of an access control system for controlling access to a door lock according to embodiments of the present disclosure.

FIG. 2 shows an enlarged view of a door lock according to embodiments of the present disclosure.

FIG. 3 shows a flowchart of an exemplary process performed by a door lock according to embodiments of the present disclosure.

FIG. 4 shows an enlarged view of a mobile device according to embodiments of the present disclosure.

FIG. 5 shows a flowchart of an illustrative process for decrypting a password embedded in a QR code according to embodiments of the present disclosure.

FIG. 6 shows an image displayed on a mobile device according to embodiments of the present disclosure.

FIG. 7 shows an image displayed on a mobile device according to embodiments of the present disclosure.

FIG. 8 shows an image displayed on a mobile device according to embodiments of the present disclosure.

FIG. 9 shows an image displayed on a mobile device according to embodiments of the present disclosure.

FIG. 10 shows an image displayed on a door lock according to embodiments of the present disclosure.

FIG. 11 shows a flowchart of an illustrative process for decrypting a password embedded in a QR code according to embodiments of the present disclosure.

FIG. 12 shows a schematic diagram of a system for implementing one or more aspects of the present disclosure.

### DETAILED DESCRIPTION OF PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components shown in the drawings are illustrative of exemplary embodiments of the present invention and are meant to avoid obscuring the invention. Furthermore, connections between components within the figures are not intended to be limited to direct connections. Rather, data between these components may be modified, re-formatted, or otherwise changed by intermediary components or devices. Also, additional or fewer connections may be used. It shall also be noted that the terms “coupled” “connected” or “communicatively coupled” shall be understood to include direct connections, indirect connections through one or more intermediary devices, and wireless connections.

Furthermore, by applying relevant technology, one skilled in the art shall recognize: (1) that certain steps may optionally be performed; (2) that steps may not be limited to the specific order set forth herein; (3) that certain steps may be performed in different orders; and (4) certain steps may be done concurrently.

In embodiments, in order to improve the security aspect of the conventional digital locks, a one-time passcode (or equivalently, password) scheme is utilized. In embodiments, with continuously changing passcode, the lock systems prevent the conventional issue of leaked passcodes. Also, in embodiments, with the use of a mobile application, the presently disclosed technology easily embeds into a ubiquitous mobile device, such as smartphone. In addition, with the encryption keys managed by a server, the grant and the removal of access to the lock systems may be done remotely in a cost effective manner.

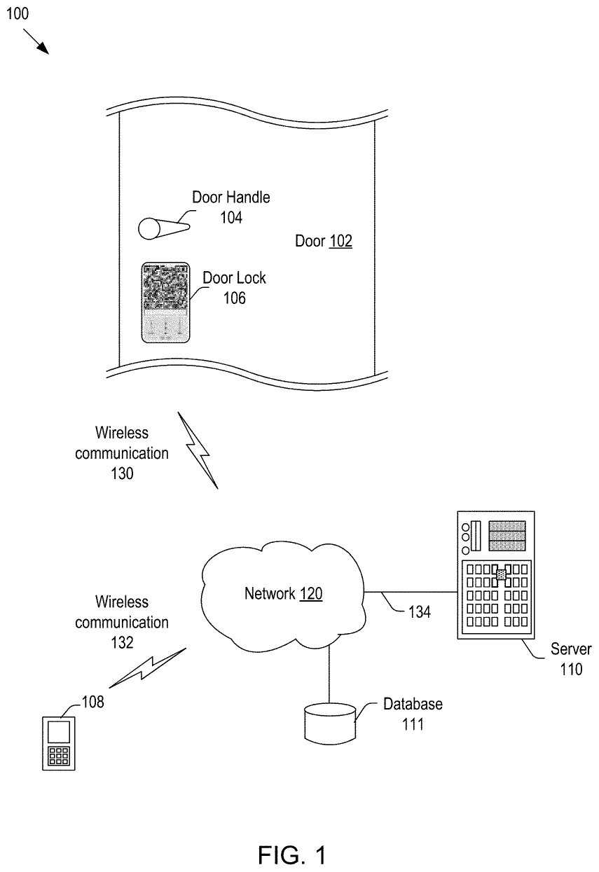

FIG. 1 shows a schematic diagram of an access control system 100 for controlling access to a door lock according to embodiments of the present disclosure. As depicted, the access control system 100 may include: a door lock (or shortly, lock) 106 mounted on a door 102; a mobile device 108; a server 110; and a network 120 for providing communication between the door lock, mobile device and server. In embodiments, the lock 106 may be communicatively coupled to the network 120 via a wireless communication channel 130, and the mobile device 108 may be communicatively coupled to the network 120 via a wireless communication channel 132. However, it should be apparent to those of ordinary skill in the art that the wireless communication channels 130 and 132 may be replaced by suitable wire channels.

For the purpose of illustration, the access control system 100 is applied to control the door lock 106 in the present disclosure. However, it should be apparent to those of ordinary skill in the art that the access control system 100 may be applied to any other suitable types of locking mechanisms. Also, it should be apparent to those of ordinary skill in the art that the door handle 104 and the lock 106 may be formed as an integral body. In embodiments, the lock 106 may include an electro-mechanical component that locks/unlocks the door 102.

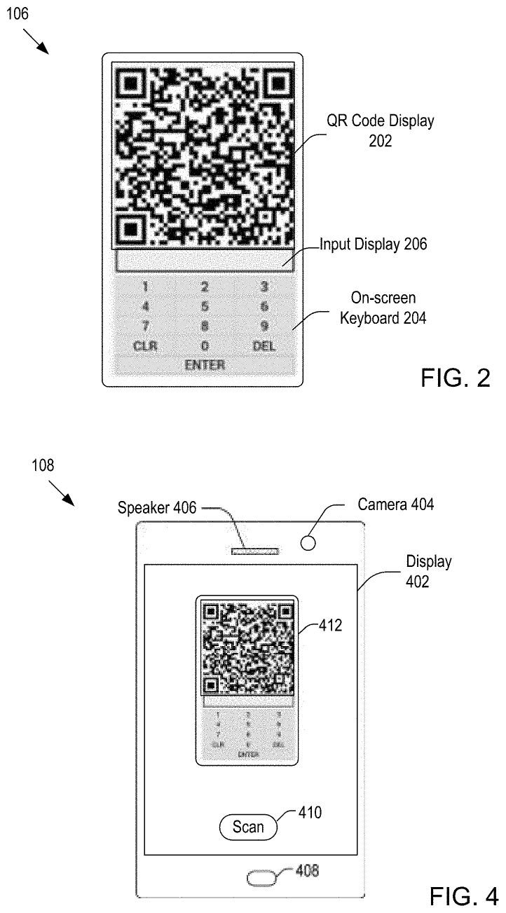

FIG. 2 shows an enlarged view of the door lock 106 according to embodiments of the present disclosure. It is noted that the lock 106 may have other suitable design and components. As depicted, the lock 106 may include a screen, which may be a touch screen, and display three images: a QR code 202; an on-screen keyboard 204; and an input display 206.

In embodiments, the lock 106 may include a computer, such as Raspberry Pi® computing system developed by Raspberry Pi Foundation, located at Cambridge, United Kingdom, and run preferably, but not limited to, an application of Python® programming language. In embodiments, the application may register the lock 106 to the server 110 the first time the application runs and receive a designated ID (i.e., lock ID) and an encryption key for encrypting the password from the server 110. In embodiments, the lock ID may be a unique ID that is assigned to the lock 106 and managed by the server 110. In embodiments, the encryption key received from the server 110 may be stored in the lock 106 and changed remotely by the server 110 via the network 120. In embodiments, the server 110 may store the lock ID and encryption key in a database 111 that may be included in the server 110 or remotely located.

In embodiments, the application of the lock 106 may use AES256 in the cypher-block-chain (CBC) mode for password encryption. In embodiments, in order to allow varying number of users to access the lock 106 (i.e. decrypt the password), the lock 106 may use a symmetric encryption scheme. In embodiments, the lock 106 may generate a random password, and encrypt the password using the encryption key. In embodiments, the password may be a combination of lowercase letters, uppercase letters, numerals, and special characters. For instance, the password may be a random 6 digit sequence.

In embodiments, the lock 106 may create a data block that includes the information of lock ID, encrypted password, and any additional information required by the encryption mechanism, such as an initialization vector, if required by the encryption algorithm. In embodiments, the lock 106 may display the data in the form of a QR code 202, i.e., the lock may generate the password-embedded QR code, and wait for user input on the on-screen keyboard 204.

In embodiments, a user who has access to the lock 106 may enter the password using the keyboard 204 to open the door 102. In embodiments, once the user enters the input, the input may be simultaneously displayed on the input display 206. Also, the lock 106 may compare the input to the password. In embodiments, if the input is not correct (i.e. different from the password), the lock 106 may deny access and wait for another user input. If the input is correct, the lock 106 may grant access, i.e., the lock may unlock to open the door 102.

In embodiments, the lock 106 may utilize the one-time password system. Thus, upon granting an access to a user, the lock 106 may generate a new random password, encrypt the new password, and generate a new data block that includes the lock ID and the newly encrypted password, and display the new data block in the form of a QR code. As such, unlike the existing lock systems, the password granted to one user cannot be leaked to and used by another user.

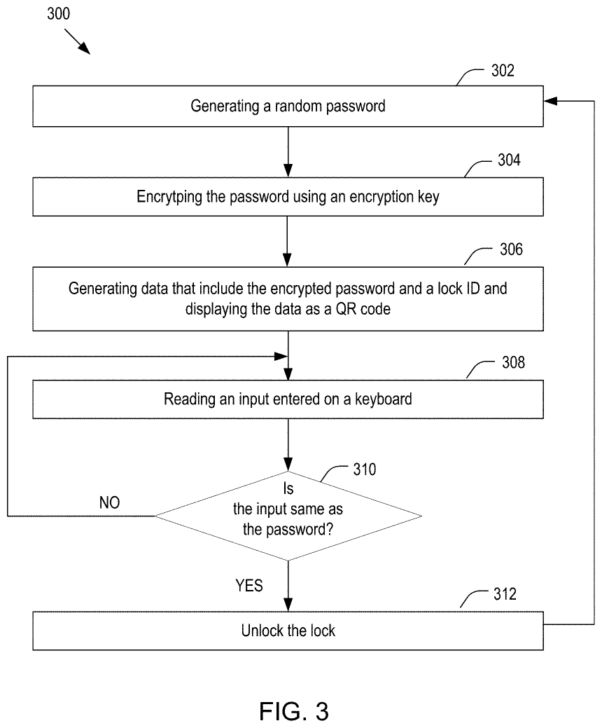

FIG. 3 shows a flowchart 300 of an exemplary process performed by the door lock 106 according to embodiments of the present disclosure. In embodiments, the lock 106 may generate a random password (step 302) and encrypt the password using an encryption key (step 304) received from the server 110. At step 306, the lock 106 may generate data that include the encrypted password and lock ID and display the data as a QR code 202 on its screen. Optionally, the data may also include an initialization vector, if required by the encryption algorithm.

Upon displaying the QR code 202, the lock 106 may wait for a user input. At step 308, the lock 106 may read the input entered on the on-screen keyboard 204 by a user. At step 310, the lock 106 may determine whether the input is the same as the password. At step 312, if the determination at step 310 is positive, the lock 106 is unlocked and the process proceeds to step 302. Otherwise, the process proceeds to step 308.

FIG. 4 shows an enlarged view of the mobile device 108 according to embodiments of the present disclosure. As depicted, the mobile device 108 may be a cell phone, even though other portable devices having cameras and GUIs may be used in place of a cell phone. In embodiments, the mobile device 108 may include: a display 402; a camera 404; a speaker 406; and a control button 408 that allows the user to select different functions of the mobile device. It is noted that the mobile device 108 may include other various components, such as microphone, and have other suitable design and arrangements of the components. In embodiments, the display 402 may be a screen, preferably, but not limited to, a touch screen, and include various GUI components for user interaction. For instance, the display 402 may display an image captured by the camera 404, such as an image 412 of the QR code 204, and a button 410 that the user touches to scan the image 412. In embodiments, the mobile device 108 may include Android® mobile operating system.

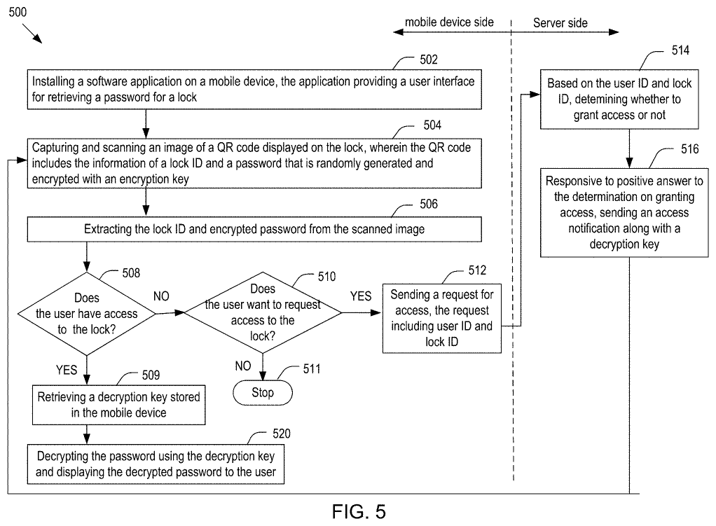

FIG. 5 shows a flowchart 500 of an illustrative process for decrypting a password embedded in the QR code 202 according to embodiments of the present disclosure. At step 502, a software application (or equivalently, mobile application) may be installed in a mobile device 108, where the mobile application may provide a user interface for retrieving a password for the lock 106, i.e., the application may allow the user to decrypt a password embedded in the QR code 202. In embodiments, the application may provide the GUIs in FIGS. 4-10 and perform one or more of the steps in FIG. 5.

At step 504, the user may operate the camera 404 to capture the image 412 of the QR code 202 displayed on the lock 106 and may touch the SCAN button 410 to scan the image 412 of the QR code. In embodiments, the QR code may include the information of the lock ID of the lock 106, the password that is randomly generated and encrypted with an encryption key, and optionally, the initialization vector, if applicable.

At step 506, the application may parse the data embedded in the scanned image 412 to extract the lock ID, encrypted password, and, optionally, the initialization vector, if applicable. In embodiments, each user has a unique ID for identification on the side of the server 110.

In embodiments, the mobile device 108 may have a storage, and the application of the mobile device may store in advance the lock IDs that the user has access to and the decryption keys corresponding to the lock IDs in the storage. At step 508, the application may compare the extracted lock ID with the lock IDs stored in the storage to determine whether the user has access to the lock 106 or not.

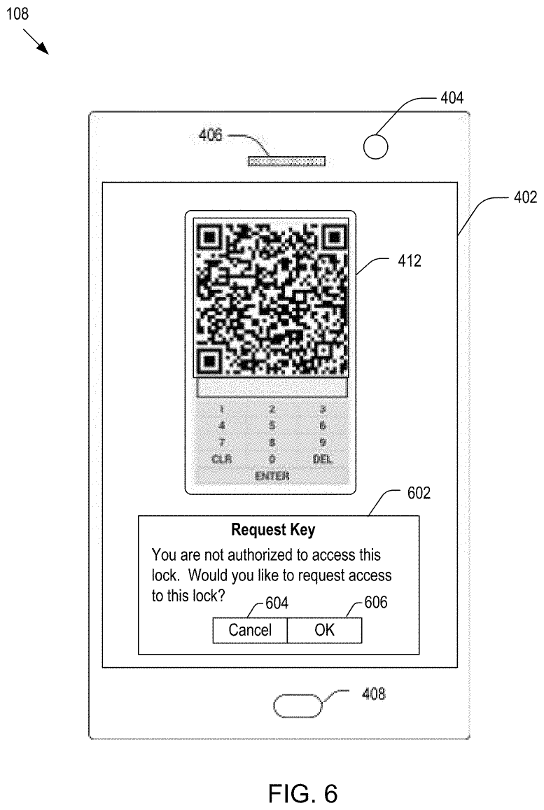

If the answer to the decision diamond 508 is negative, the process proceeds to step 510. At step 510, the application of the mobile device 108 may query the user whether the user would like to request access to the lock 106. For instance, the application of the mobile device may display a new GUI component(s), such as a window 602 in FIG. 6. FIG. 6 shows an image displayed on the mobile device 108 according to embodiments of the present disclosure. As depicted, the display 402 may include the image 412 of the QR code and a “Request Key” window 602, where the window 602 may display a message “You are not authorized to access this lock. Would you like to request access to this lock?” and two buttons, “Cancel” 604 and “OK” 606.

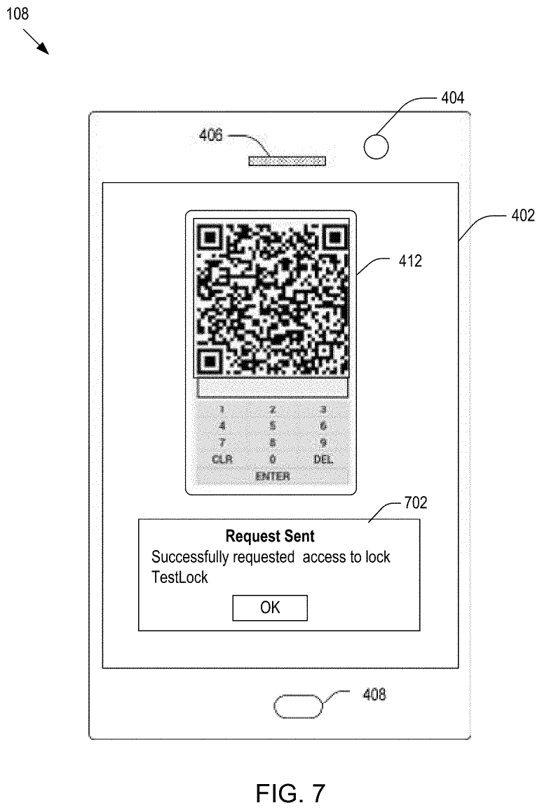

If the user touches the “Cancel” button 604, the process may stop at step 511. If the user touches the “OK” button 606, the process proceeds to step 512 and, at the same time, the application may display an acknowledgement message to the user. FIG. 7 shows an image displayed on the mobile device 108 according to embodiments of the present disclosure. As depicted, the display 402 may include the image 412 of the QR code and a “Request Sent” window 702, where the window 702 may display an acknowledgement message “Successfully requested access to lock TestLock.”

At step 512, the application of the mobile device 108 may send an access request to the server 110, asking for access to the lock 106. In embodiments, the access request may include information to identify the user requesting the access (user ID), the information to identify the lock the user is requesting access to (lock ID) and any cryptographic data required to confirm the user, such as a password.

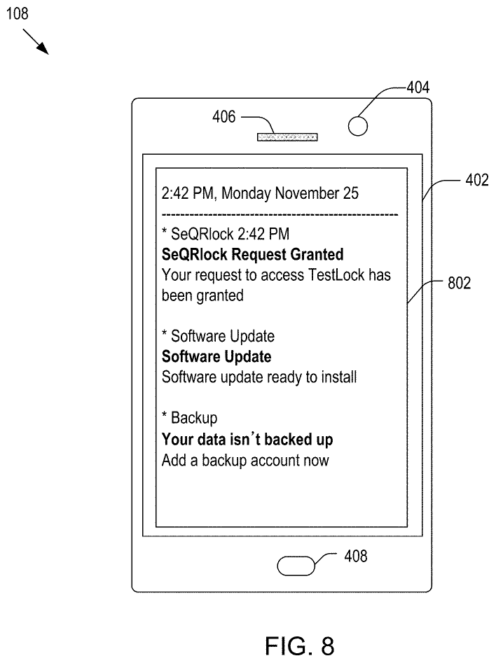

At step 514, the server (or administrator) 110 may determine, based on the information included in the access request, whether to grant access or not. If the answer to the determination at step 514 is negative, the server 110 may send a message to the mobile device 108, denying access to the lock. At step 516, responsive to a positive answer to the determination at step 514, the server 100 may send an access notification to the mobile device 104, where the access notification may include a decryption key for decrypting the encrypted password and other notification messages containing information of the lock 106 that the user gained access to. FIG. 8 shows an image displayed on the mobile device 108 according to embodiments of the present disclosure. As depicted, the display 402 may include a window 802 that displays various messages that are included in the access notification received from the server 110. Then, the process proceeds to step 504 and repeats steps 504-508.

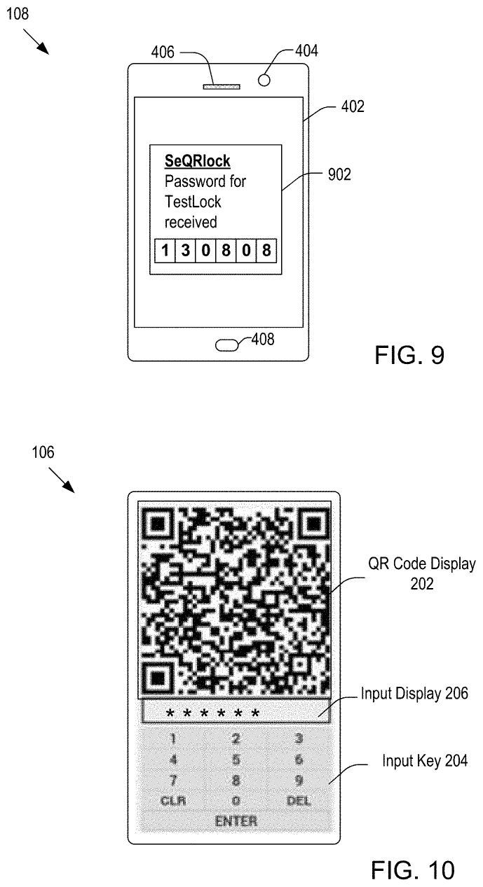

In embodiments, upon positive answer to the decision diamond 508, the process proceeds to step 509. At step 509, the application of the mobile device 108 may retrieve the decryption key stored in the mobile device. It is noted that the application of the mobile device 108 may store in advance the decryption key for the lock 106 in the storage of the mobile device 108. Then, at step 520, the application of the mobile device 108 may use the decryption key to decrypt the password. In embodiments, at step 520, the application of the mobile device 108 may also display the decrypted password to the user. FIG. 9 shows an image displayed on the mobile device 108 according to embodiments of the present disclosure. As depicted, the display 402 may display a window 902 that shows the decrypted password “130808.”

In embodiments, upon displaying the decrypted password on the mobile device 108, the user may enter the decrypted password “130808” on the on-screen keyboard 204. FIG. 10 shows an image displayed on the door lock 106 according to embodiments of the present disclosure. As depicted, the lock 106 may display an asterisk on the input display 206 each time the user touches a key on-screen keyboard 204 to enter the decrypted password. Upon receiving the matching password, the lock 106 may unlock to open the door 102.

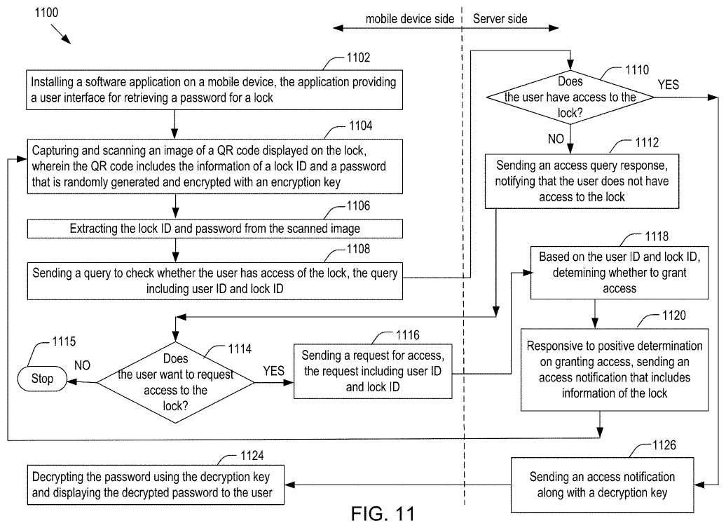

In some embodiments, the application of the mobile device 108 may not store the decryption keys in a storage of the mobile device 108; instead, the application may receive the decryption key from the server 110 by sending a request whenever necessary. As such, in some embodiments, the application of the mobile device 108 may not be able to determine whether the use has access to the lock 106 or not, i.e., the application of the mobile device is not able to perform step 508. FIG. 11 shows a flowchart 1100 of an illustrative process for decrypting a password embedded in a QR code according to embodiments of the present disclosure. In embodiments, the flowchart 1100 may correspond to the cases where the mobile device 108 does not store the decryption keys in its storage. At step 1102, a software application (or equivalently, mobile application) may be installed in the mobile device 108, where the mobile application may provide a user interface for retrieving a password for the lock 106, i.e., the application may allow the user to decrypt a password embedded in the QR code 202.

At step 1104, the user may operate the camera 404 to capture an image 412 of the QR code 202 displayed on the lock 106 and may touch the SCAN button 410 (shown in FIG. 4) to scan the image 412 of the QR code. In embodiments, the QR code may include the information of the lock ID of the lock 106, the password that is randomly generated and encrypted with an encryption key, and optionally, the initialization vector, if applicable.

At step 1106, the application may parse the data embedded in the image 412 to extract the lock ID, encrypted password, and, optionally, the initialization vector, if applicable. In embodiments, each user has a unique ID for identification on the side of the server 110.

In embodiments, the application installed in the mobile device 108 may not have information of the list of users who have access to the lock ID; instead, the server 110 may have the information of the lock ID and the list of users that have access to the lock 106. As step 1108, the application may send an access query to the server to check whether the user has access to the lock 106. In embodiments, the access query may include the information to identify the user requesting access (user ID), information to identify the lock the user is requesting access to (lock ID), and any cryptographic data required to confirm the user, such as a password.

At step 1110, the server (or administrator) 110 may determine whether the user has access to the lock 106 or not. Upon negative answer to step 1110, the server 110 may send an access query response, notifying that the user does not have access to the lock 106 at step 1112. Then, the process proceeds to step 1114.

At step 1114, the application of the mobile device 108 may query the user whether the user would like to request access to the lock 106. In embodiments, the application may display a window 602 in FIG. 6. As depicted in FIG. 6, the display 402 may include the image 412 of the QR code and the “Request Key” window 602, where the window 602 may display a message “You are not authorized to access this lock. Would you like to request access to this lock?” and two buttons, “Cancel” 604 and “OK” 606. If the user touches the “Cancel” button 604, the process may stop at step 1115. If the user touches the “OK” button 606, the process proceeds to step 1116 and, at the same time, the application of the mobile device 108 may display a notification message to the user. As depicted in FIG. 7, the display 402 may include the image 412 of the QR code and the “Request Sent” window 702, where the window 702 may display a notification message “Successfully requested access to lock TestLock.”

At step 1116, the application may send an access request to the server 110, where the access request may include the information to identify the user requesting the access (user ID), the information to identify the lock the user is requesting access to (lock ID) and any cryptographic data required to confirm the user, such as a password.

At step 1118, the server (or administrator) 110 may determine, based on the information included in the request for access, whether to grant access or not. At step 1120, responsive to a positive answer to the determination at step 1118, the server 100 may send an access notification to the mobile device 104, where the access notification may include notification messages containing information of the lock 106 that the user gained access to. As depicted in FIG. 8, the display 402 may include the window 802 that displays the messages that are included in the access notification received from the server 110. Then, the process proceeds to step 1104 and repeats steps 1104-1108.

In embodiments, upon a positive answer to step 1110, the process proceeds to step 1126. At step 1126, the server 110 may send an access notification along with a decryption key that is used to decrypt the encrypted password. Then, the process proceeds to step 1124.

At step 1124, the application of the mobile device 108 may decrypt the encrypted password using the decryption key and display the decrypted password to the user. As depicted in FIG. 9, the display 402 may display a window 902 that shows the decrypted password “130808.” Then, as described in conjunction with FIG. 10, the lock 106 may display an asterisk on the input display 206 each time the user touches a key in the on-screen keyboard 204 to enter the decrypted password. Upon receiving the matching password, the lock 106 may unlock to open the door 102.

In embodiments, the system 100 takes advantage of modern cryptographic technology to enhance the security. With the implementation of the one-time password scheme, the system 100 may prevent any security flaws caused from a leaked password, as the previously used password will no longer be valid. The system 100 may also remove the inconvenience of users ever having to change the password, memorize them and transmit the change to other users who require access, as users with access will always be able to read the password off of their mobile devices. In the system 100, the server 110 may operate as a central controller for handling grant or removal of access of certain users without affecting the experience of other users.

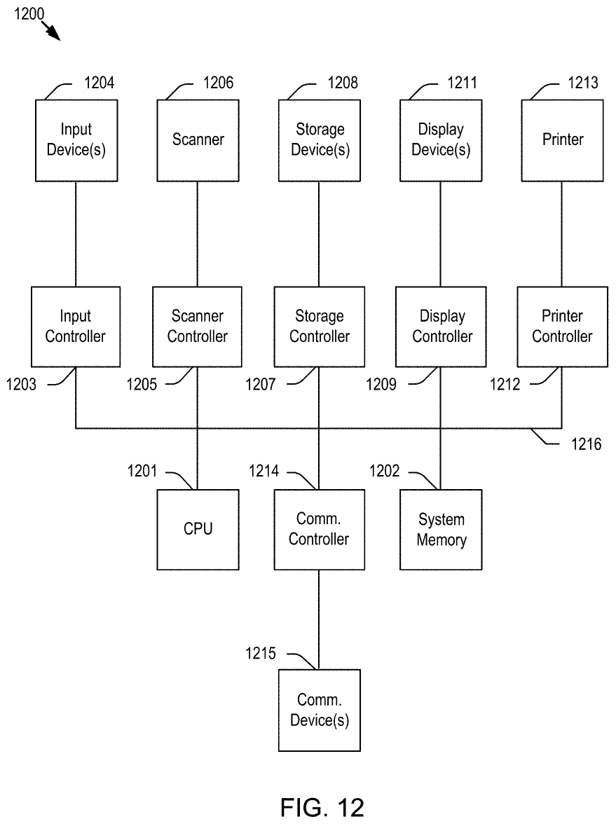

FIG. 12 shows a schematic diagram of a system 1200 for implementing one or more aspects of the present disclosure. It will be understood that the functionalities shown for system 1200 may operate to support various embodiments of the electronic devices (such as mobile devices, servers and locks) shown in FIGS. 1-11—although it shall be understood that an electronic device may be differently configured and include different components. As illustrated in FIG. 12, system 1200 includes a central processing unit (CPU) 1201 that provides computing resources and controls the computer. CPU 1201 may be implemented with a microprocessor or the like, and may also include a graphics processor and/or a floating point coprocessor for mathematical computations. System 1200 may also include a system memory 1202, which may be in the form of random-access memory (RAM) and read-only memory (ROM).

A number of controllers and peripheral devices may also be provided, as shown in FIG. 12. An input controller 1203 represents an interface to various input device(s) 1204, such as a keyboard, mouse, or stylus. There may also be a scanner controller 1205, which communicates with a scanner 1206. System 1200 may also include a storage controller 1207 for interfacing with one or more storage devices 1208 each of which includes a storage medium such as magnetic tape or disk, or an optical medium that might be used to record programs of instructions for operating systems, utilities and applications which may include embodiments of programs that implement various aspects of the present invention. Storage device(s) 1208 may also be used to store processed data or data to be processed in accordance with the invention. System 1200 may also include a display controller 1209 for providing an interface to a display device 1211, which may be a cathode ray tube (CRT), a thin film transistor (TFT) display, or other type of display. System 1200 may also include a printer controller 1212 for communicating with a printer 1213. A communications controller 1214 may interface with one or more communication devices 1215, which enables system 1200 to connect to remote devices through any of a variety of networks including the Internet, an Ethernet cloud, an FCoE/DCB cloud, a local area network (LAN), a wide area network (WAN), a storage area network (SAN) or through any suitable electromagnetic carrier signals including infrared signals.

In the illustrated system, all major system components may connect to a bus 1216, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

What is claimed is:

1. A lock, comprising:
a display for displaying a quick response (QR) code and an on-screen keyboard;
one or more processors; and
a non-transitory computer-readable medium comprising one or more sequences of instructions which, when executed by the one or more processors, causes steps to be performed comprising:
(a) generating a password;
(b) encrypting the password with an encryption key;
(c) generating data that include information of the encrypted password and an identification (ID) of the lock;
(d) displaying the data as a QR code on the display;
(e) reading an input entered on the on-screen keyboard;
(f) responsive to matching the input and the password, unlocking the lock and repeating the steps (a)-(d).

2. A lock as recited in claim 1, wherein the data further includes an initialization vector that is required to encrypt the password.

3. A lock as recited in claim 1, wherein the steps further comprises:
registering the lock to a server; and
receiving the ID of the lock and the encryption key from the server.

4. A mobile device for retrieving a password embedded in a quick response (QR) code, comprising:
a display;
one or more processors; and
a non-transitory computer-readable medium comprising one or more sequences of instructions which, when executed by the one or more processors, causes steps to be performed comprising:
(a) capturing and scanning an image of a QR code that is displayed on a lock and includes information of an identification (ID) of the lock and a password encrypted with an encryption key;
(b) extracting the ID of the lock and the encrypted password from the scanned image;
(c) sending a request for access of the lock, the request including the ID of the lock and an ID of a user;
(d) receiving an access notification that includes a decryption key;
(e) decrypting the encrypted password using the decryption key; and
(f) displaying the decrypted password on the display, wherein the decrypted password is used to unlock the lock.

5. A mobile device as recited in claim 4, wherein the steps further comprises, after the step (b):
determining whether the user has an access to the lock; and
if an answer to the determination is negative, proceeding to the step (c); and
otherwise, retrieving the decryption key stored in the mobile device and proceeding to the step (e).

6. A mobile device as recited in claim 4, wherein the steps further comprises, after the step (b):
querying the user whether the user wants to request access; and
if an answer to the query is negative, terminating a process for retrieving the password; and
otherwise, proceeding to step (c).

7. A computer-implemented method for retrieving a password embedded in a quick response (QR) code, comprising:
(a) capturing and scanning an image of a QR code that is displayed on a lock and includes information of an identification (ID) of the lock and a password encrypted with an encryption key;
(b) extracting the ID of the lock and the encrypted password from the scanned image;
(c) sending a request for access of the lock, the request including the ID of the lock and an ID of a user of a mobile device;
(d) receiving an access notification that includes a decryption key;
(e) decrypting the encrypted password using the decryption key; and
(f) displaying the decrypted password on a display of the mobile device, wherein the decrypted password is used to unlock the lock.

8. A computer-implemented method as recited in claim 7, further comprising, after the step (b):
determining whether the user has an access to the lock; and
if an answer to the determination is negative, proceeding to the step (c); and
otherwise, retrieving the decryption key stored in the mobile device and proceeding to the step (e).

9. A computer-implemented method as recited in claim 7, further comprising, after the step (b):
querying the user whether the user wants to request access; and
if an answer to the query is negative, terminating a process for retrieving the password; and
otherwise, proceeding to step (c).

10. A mobile device for retrieving a password embedded in a quick response (QR) code, comprising:
a display;
one or more processors; and
a non-transitory computer-readable medium comprising one or more sequences of instructions which, when executed by the one or more processors, causes steps to be performed comprising:
(a) capturing and scanning an image of a QR code that is displayed on a lock and includes information of an identification (ID) of the lock and a password encrypted with an encryption key;
(b) extracting the ID of the lock and the encrypted password from the scanned image;
(c) sending a query to check whether a user of the mobile device has access to the lock, the query including the ID of the lock and an ID of the user;
(d) receiving an access notification that includes a decryption key;
(e) decrypting the encrypted password using the decryption key; and
(f) displaying the decrypted password on the display, wherein the decrypted password is used to unlock the lock.

11. A mobile device as recited in claim 10, wherein the steps further comprises, after the step (c):
(g) receiving an access query response notifying that the user does not have access to the lock;
(h) sending a request for access of the lock, the request including the ID of the lock and the ID of the user; and
(i) responsive to receiving an access notification, proceeding to step (a).

12. A mobile device as recited in claim 11, wherein the steps further comprises, after the step (g):
querying the user whether the user wants to request access; and
if an answer to the query is negative, terminating a process for retrieving the password; and
otherwise, proceeding to step (h).

13. A computer-implemented method for retrieving a password embedded in a quick response (QR) code, comprising:
(a) capturing and scanning an image of a QR code that is displayed on a lock and includes information of an identification (ID) of the lock and a password encrypted with an encryption key;
(b) extracting the ID of the lock and the encrypted password from the scanned image;
(c) sending a query to check whether a user of a mobile device has access to the lock, the query including the ID of the lock and an ID of the user;
(d) receiving an access notification that includes a decryption key;
(e) decrypting the encrypted password using the decryption key; and
(f) displaying the decrypted password on the display, wherein the decrypted password is used to unlock the lock.

14. A computer-implemented method as recited in claim 13, further comprising, after the step (c):
(g) receiving an access query response notifying that the user does not have access to the lock;
(h) sending a request for access of the lock, the request including the ID of the lock and the ID of the user; and
(i) responsive to receiving an access notification, proceeding to step (a).

15. A computer-implemented method as recited in claim 14, further comprising, after the step (g):
querying the user whether the user wants to request access; and
if an answer to the query is negative, terminating a process for retrieving the password; and
otherwise, proceeding to step (h).
